(19) United States
(12) Patent Application Publication
(10) Pub. No.: US 2021/0321650 A1
(43) Pub. Date: Oct. 21, 2021

(54) COLORING ADDITIVE

(71) Applicant: Sanluc International NV, Gijzenzele (BE)

(72) Inventors: Luc Goethals, Gijzenzele (BE); Marie-Hélène Degrave-Sanier, Lille (FR)

(21) Appl. No.: 17/413,977

(22) PCT Filed: Dec. 19, 2019
(86) PCT No.: PCT/EP2019/086415

§ 371 Date: Jun. 15, 2021

(30) Foreign Application Priority Data
Dec. 20, 2018 (NL) 2022270

(51) Int. Cl. A23L 5/43; C09B 61/00; A23K 20/179; A23L 2/58; A23L 2/385; A23K 10/30

(52) U.S. Cl. CPC A23L 5/43; C09B 61/00; A23K 20/179; A23V 2002/00; A23L 2/385; A23K 10/30; A23L 2/58

(57) ABSTRACT

The invention relates to a coloring additive for food or feed, comprising a water extract of sweet chestnut wood comprising sweet chestnut tannins. The additive can be in granular or liquid form. The amount of tannins in the sweet chestnut wood extract is about 40 wt % or more, preferably 40 to 60 wt % expressed as total polyphenols, calculated on dry matter. The coloring additive is a.o. suitable as replacement of caramel color class IV in soft drinks.

### TECHNICAL FIELD

The invention relates to a brownish coloring additive for food or feed applications.

### BACKGROUND ART

Caramel is a widely used coloring agent. Internationally, the United Nations Joint Food and Agriculture Organization/World Health Organization Expert Committee on Food Additives recognizes four classes of caramel color, differing by the reactants used in their manufacture. Each class consists of a variety of caramels with specific properties that make it suitable for use in specific foods and/or beverages.

Class I comprises plain caramel, caustic caramel and spirit caramel. It has a substantial taste and mild aroma; the color ranges from yellow to red. This grade is mainly used in whiskey and other high proof alcohols, pet food, cookies, crackers, cereal bars, other baked goods, lemonade products, juice concentrates, and cocoa extenders. Class II is also named caustic sulfite caramel and has a mild flavor and aroma and a clear red tone. This grade is mainly used in tea, wine, rum, whiskey, brandy, cognac, sherry, some vinegars, light cake mixes, and other snack foods. Grade III is also named ammonia caramel, baker's caramel, confectioner's caramel or beer caramel, has a sweet aroma and red-brown color. Grade III is most used in beer, cereal, pet food, licorice, confectionery, gravy, soy, and BBQ sauce. Grade IV also named sulfite ammonia caramel, acid-proof caramel or soft-drink caramel, has a very mild flavor and aroma and a rich dark brown color. This grade is mainly used in soft drinks and other carbonated beverages, balsamic vinegar, coffee, chocolate syrups, baked goods, cocoa extenders, pet foods, sauces, soups, meat rubs, seasoning blends, and other flavorings.

In particular grade III and IV caramel colors are dark brown to black liquids or solids having an odor of burnt sugar and a pleasant, somewhat bitter taste. They are totally miscible with water and contain colloidal aggregates that account for most of their coloring properties and characteristic behavior toward acids, electrolytes, and tannins.

Caramel colors are prepared by controlled heat treatment of carbohydrates. The carbohydrate raw materials used are commercially available food-grade nutritive sweeteners, which are the monomers glucose and fructose or polymers thereof (e.g., glucose syrups, sucrose or invert sugars, and dextrose). To promote caramelization, food-grade acids, alkalis, and salts may be used in amounts consistent with Good Manufacturing Practices (GMP) and subject to the following stipulations. Ammonium and sulfite compounds cannot be used as reactants for Class I caramel colors. Sulfite compounds must be used and ammonium compounds cannot be used as reactants for Class II caramel colors. Ammonium compounds must be used and sulfite compounds cannot be used as reactants for Class III caramel colors. Both ammonium and sulfite compounds must be used as reactants for Class IV caramel colors.

The ammonium compounds used are hydroxides, carbonates, bicarbonates, phosphates, sulfates, sulfites, and bisulfites. The sulfite compounds are sulfurous acid and sulfites and bisulfites of potassium, sodium, and ammonium. Sulfuric and citric acid and sodium, potassium, and calcium hydroxide are compounds that can be used for all four types of caramel color.

Caramel Colour III and IV are therefore prepared by the controlled heat treatment of carbohydrates with ammonium-containing compounds. This treatment may cause the synthesis of 4-methyl-imidazol. Even though the amount of methyl-imidazol is low, and is considered harmless, there is an ongoing discussion about its safety. Further, most caramel grades require chemical modification causing the ingredient to not conform with biological food requirements.

CN103937290 describes the use of several natural pigments that are available, such as scorpion yellow pigment, cochineal red pigment, chestnut shell brown pigment, natural orange red pigment, cocoa shell pigment, grape skin pigment, safflower yellow pigment, malt pigment, curcumin and their compounds. Remaining disadvantages comprise poor stability, such as natural orange red pigment, and such as chestnut shell pigment. After a while, the color will become darker and will precipitate, and it will not meet the “stable” requirements of the color of for example wine.

The present invention provides an alternative for caramel colors, and in particular for grade III and IV color, and even more in particular for grade IV caramel.

More in particular, the present invention provides for an alternative coloring additive that is considered ‘natural’, because no synthetic chemicals are used during the manufacturing.

Several patent applications are published, mentioning the use of sweet chestnut shell extract as coloring agent, see for example CN-B-103232725, CN-A-1765206, CN-A-103387755 and CN-A-106189354. However, chestnut shell extracts require chemical treatments, like the use of alkali's, or acids and ethanol. Therefore, these extracts are not suitable as fully natural coloring agents.

### SUMMARY OF THE INVENTION

It is an object of the invention to provide brownish coloring agent that can be used as an alternative, replacing in total, or partially, caramel colors.

The present invention provides for the use of a water extract of sweet chestnut wood as a coloring agent.

The present invention furthermore provides a concentrated soft drink comprising water extract of sweet chestnut wood.

The present invention furthermore provides a cola drink comprising a water extract of sweet chestnut wood.

The water extract of sweet chestnut is effective as a coloring agent, capable of replacing all or part of class IV caramel in cola drinks or the like. It is furthermore an advantage that the tannins that are the main constituents of the water extract of sweet chestnut wood are considered anti-bacterial and anti-inflammatory agents and have health benefits over caramel coloring agents.

### DETAILED DESCRIPTION

The coloring agent according to the present invention comprises a water extract of sweet chestnut wood comprising sweet chestnut tannins. The wood is also called bark, no difference is intended.

In one embodiment of the invention, the coloring agent is in solid form, like powder or granules.

In another embodiment of the invention, the coloring agent is in the form of a liquid.

Water extract of sweet chestnut wood comprises tannins. These tannins are largely not condensed. Tannins from chestnut wood are known as a food additive, leather tanning processes, feed additive and the like. Tannins are used as feed additive in poultry to lower bacterial pressure, with little effect on growth (see e.g. Poultry Science (2008) 87:521-527). In the use as feed additive, the extract generally is mixed as powder through other feed ingredients.

The amount of tannins in the water extract generally is about 40 wt % or more, preferably between 40-60 wt %, more preferably 45 and 55 wt % expressed as total polyphenols and with a dominant part as ellagic acid (or esters therefrom), calculated on dry matter. Higher concentrated extracts would be suitable as well. Tannins from sweet chestnut wood comprise gallic acid and ellagic acid, and hydrolysable esters therefrom with monosaccharides, like vescalin, castalin, vescalagin and castalagin.

The water extract of sweet chestnut wood for use as coloring agent according the present invention can be obtained by water extraction of chestnut wood. Water extraction is well known, and such water extracts are commercially available. Examples of suitable sources of tannin include: Silvafeed (Silva srl—Italy), Farmatan or Globatan (Tanin Sevnica—Slovenia), King Brown or Tanno-SAN (King Tree France, Sanluc Belgium). The product generally is supplied as powder or granule, but can also be used in liquid form, with e.g. about 50 wt % solids.

The extraction of tannins from sweet chestnut wood does not require any chemical modification, and the resulting tannin extract is therefore a fully biological additive. This is a distinction with extracts from chestnut shells, that require alcohol or other organic solvents.

The amount of sweet chestnut concentrate in the food or feed product can vary, and may be as high as 2 wt % or less. Preferably, the amount will be about 1 wt % or less.

The amount of sweet chestnut extract, comprising the sweet chestnut tannin, in a soft drink concentrate generally will be about 0.1%-0.8% of commercially available dry chestnut extract dissolved in the soft drink. Preferably, the amount is about 0.2-0.5 wt %. The sweet chestnut extract may be diluted with e.g. bulking material, in which case the amounts will be calculated relative to the chestnut extract only.

The sweet chestnut extract can be used as coloring agent in combination with other, preferably natural, coloring agents. Suitable coloring agents include scorpion yellow pigment, cochineal red pigment, natural orange red pigment, cocoa shell pigment, grape skin pigment, safflower yellow pigment, malt pigment, curcumin and their compounds and grade I caramel color if made without non-natural components.

Color ratio measurement can be done as follows: prepare a 0.1% sample dilution. Use the 0.1% sample dilution in a lcm cuvette with distilled water as a reference, and measure the optical density OD1 value at 610 nm with UV spectrophotometer. Preferably, the measurement is repeated three times, and the average OD1 value is used, The EBC color strength is calculated as follows: Color rate (EBC unit)=OD1×20,000/0.076

The red index can be determined in an analogous way: Use a wavelength of 510 nm in the optical density measurement and measure an OD2, and the red index is calculated as follows: Red index=10×(OD2/OD1).

### EXAMPLES

Two water extracts of bark of sweet chestnut were compared with caramel type IV (E150d).

The dry matter content was measured after drying for 48 hr at 105 dgr C. The results were as follows:

| | Dry matter (n = 3) | | |
|---|---|---|---|
| | g/100 g | | RSD |
| Product | of original | SD | (%) |
| Tannin Powder | 92.54 | 0.07 | 0.1 |
| Liquid Tannin | 46.22 | 0.02 | 0.0 |
| Liquid Caramel | 50.16 | 0.05 | 0.1 |
| type IV | | | |

Color measurements were done according to the standard practice, measuring the optical density of 0.1 wt % caramel, dissolved in ultra-pure water at pH 6.2. The result was a value of 0.253±0.002 (n=3). Next, tannin solutions were prepared of 1.2% (m/v) in ultra pure water (pH=6.2). After filtration (because the tannin extracts were slightly hazy, the optical density was measured, at a dilution range down to 0.1 wt %. Next, the amount was determined to achieve the same optical density as the caramel type IV product. The results were as follows:

| | Coloring strength (n = 3) | | |
|---|---|---|---|
| | % | | RSD |
| Product | (m/v) | SD | (%) |
| Tannin Powder | 0.86 | 0.03 | 3.1 |
| Liquid Tannin | 1.04 | 0.09 | 9.0 |
| Liquid Caramel | 0.1 | Reference | |
| type IV | | | |

Further characterization revealed that the amount of hydroxymethyl furfural was one tenth or less in the tannin extracts when compared with the liquid caramel type IV. The much lower value of this hydroxy-aldehyde lowers the risk of unwanted Maillard reactions, and increases stability.

Further characterization showed that the amount of polyphenols was 15-20 times higher in the tannin products.

Next, the antioxidant activity of the tannin extracts was compared with caramel type IV. The radical DPPH (1,1-Diphenyl-2-picryhydrazyl) was used. The reduction of the radical DPPH by an antioxidant can be measured with a spectrophotometer. The reduction of the absorbance at 517 nm is induced by the presence of an antioxidant. DPPH is initially violet, and decolorizes when the free electron disappears. Such decolouration is representative of the antioxidant capacity of the measured species independent of any enzymatic activity.

Measurements were performed such that the IC50 was determined. Results are as follows:

| | IC50 (n = 3) | | | | |
|---|---|---|---|---|---|
| | μg | | μg | | RSD |
| Product | (on original) | SD | (on dry wt) | SD | (%) |
| Tannin Powder | 31.2 | 1.0 | 28.8 | 0.9 | 3.1 |
| Liquid Tannin | 55.3 | 1.8 | 25.5 | 0.8 | 3.2 |
| Liquid Caramel | 897.6 | 113.4 | 450.0 | 56.8 | 12.6 |
| type IV | | | | | |

These experiments show, that next to the coloring agent being completely natural (no chemical used for extraction), it has health benefits because of good antioxidant properties.

1. Food or feed product comprising a coloring additive, the coloring additive being a water extract of sweet chestnut wood, the extract comprising sweet chestnut tannins.

2. The product according to claim 1, wherein the amount of tannins in the sweet chestnut wood extract is about 40 wt % or more expressed as total polyphenols, calculated on dry matter.

3. The product according to claim 1, wherein the tannins in the sweet chestnut wood extract comprise gallic acid and ellagic acid, and hydrolysable esters therefrom with monosaccharides.

4. The product according to claim 1, wherein the product is a food product, which is a cola drink concentrate.

5. The product according to claim 4, wherein the coloring agent is present in 0.1-1 wt %.

6. The product according to claim 1, wherein the product is a food product, which is a cola drink.

7. The product according to claim 6, wherein the coloring agent is present in 0.0001-0.05 wt %.

8. Use of a water extract of sweet chestnut wood, the extract comprising sweet chestnut tannins, as a coloring agent in human food or animal feed.

9. Use according to claim 8, wherein the coloring additive is in granular form.

10. Use according to claim 8, wherein the additive is in liquid form

11. Use according to claim 8, wherein the amount of tannins in the sweet chestnut wood extract is about 40 wt % or more expressed as total polyphenols, calculated on dry matter.

12. Use according to claim 8, wherein the tannins in the sweet chestnut wood extract comprise gallic acid and ellagic acid, and hydrolysable esters therefrom with monosaccharides.
